(19) United States
(12) Patent Application Publication
(10) Pub. No.: US 2008/0231474 A1
(43) Pub. Date: Sep. 25, 2008

(54) Airport runway warning system

(76) Inventors: Kun-Yuan Chang, Taipei City (TW); Shing-Wei Yang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/822,449

(22) Filed: Jul. 6, 2007

(30) Foreign Application Priority Data
Mar. 23, 2007 (TW) 96110251

(51) Int. Cl. G08G 5/00

(52) U.S. Cl. 340/983

(57) ABSTRACT

A airport runway warning system disposes a number of warning lanterns parallel to the runway by the two sides of the runway. Also, every warning lantern is at least connected to one empty sensor, to sense the nearby runway zone. All the warning lanterns and sensors are connected to a central controlling unit, disposed on the airport control tower. The central controlling unit, furthermore, connects to the main displaying light in the entrance of every communication path. By the operation in coordination via every warning lantern, sensor, central controlling unit and main displaying light, additional runway real-time information can be provided to the pilot and the people in the control tower. Particularly, the obstacles appearing on the runway abruptly can also be warned immediately.

### BACKGROUND OF THE INVENTION

1. Field of the Invention

The present invention relates to a airport runway warning system for aviation safety, and particularly relates to a airport runway warning system for providing immediate status of a runway when the aircraft takes off or lands.

2. Description of the Related Art

Aviation safety can be divided into two main parts: the aviation safety when the aircraft is flying in the air and the aviation safety when the aircraft is taking off or landing. The aviation safety leading to accidents cause damages catastrophically. Responsible government units and aircraft manufacturers in countries have invested heavily with money and strength and have developed related state-of-the-art electronic supporting devices, for example, radar control, auto pilot, global positioning system, and anti-collision system etc., thus increases the aviation safety dramatically.

However, when the aircraft is taking off or landing, a lot of information on managing and directing people is involved. Hence, when the aviation control people or aircraft pilots are careless, mentally relaxing, or do not concentrate, problems would easily occur, such as moving into the wrong runway, erroneous judgment of information, unaware of obstacles in the runway, cannot see control due to bad sight, misinterpretation of messages due to bad communication, and cannot obtain real-time information due to communication breaking off etc., these are the blind corners of aviation safety on the ground.

According to the aforementioned, the inventor has, particularly, researched for ground safety and came up with the present invention of [symbol] airport runway warning system [symbol] under the original safety framework. In order to provide runway real-time information for the aviation control people and aircraft pilots to eliminate the blind corners in ground safety, necessary warning system should be added.

### SUMMARY OF THE INVENTION

The present invention of a airport runway warning system disposes a number of warning lanterns parallel to a runway by the two sides of the runway. Also, every warning lantern is at least connected to one empty sensor, to sense the nearby runway zone. All the warning lanterns and sensors are connected to a central controlling unit, disposed on the airport control tower. The central controlling unit, furthermore, connects to the main displaying light, which could be switched between red and green illuminant, in the entrance of every communication path. When any one sensor sensed obstacles on the runway, the corresponding warning lanterns and all the main displaying lights will display red illuminant to warn that the runway is not under empty condition.

Every aforementioned warning lantern, faced to the two ends of the runway, has an illuminating part. The illuminating part can be switched between red and green illuminant and the side closest to the ground can be controlled to display green illuminant and the side not closest to the ground can be controlled to display red illuminant. When putting into practice, the illuminating part includes several red and green LED for operating in coordination with the differences in visibility caused by weather to adjust the strength of the beam. Also, the sensor can be placed on top of the warning lantern for easy manufacturing and installation.

The present invention is composed by the aforementioned components to form the airport runway warning system, including the following main controlling methods:

When all the sensors sensed no obstacles in the nearby runway zone after a period of preset time, all the warning lanterns and main displaying lights display green illuminant.

When any one sensor sensed obstacles in the nearby runway zone, the warning lantern connected to the sensor will display red illuminant and cause all the main displaying lights to display red illuminant and emit signal of obstacle to the central controlling unit. At the same time, causing other warning lanterns that display red illuminant, due to obstacles sensed earlier, to continue displaying in red illuminant condition.

When the control tower permits aircrafts to take off or land, all the main displaying lights will display green illuminant via the central controlling unit and causing the illuminating parts, corresponded to the starting end for taking off and landing of aircrafts, of every warning lantern to display green illuminant. Hence, letting the aircraft on the ground know that the runway is empty. At the same time, on the other side of every warning lantern, red illuminant will be displayed to avoid reverse entering into the runway for taking off and landing of aircrafts.

If the conditions are like the abovementioned when aircraft is taking off, all the warning lanterns and main displaying lights on the runway should display green illuminant. Nevertheless, when putting into practice, in order to ensure the runway is empty and to avoid situation when aircrafts are waiting for take off in the taxiway to mis-entering the runway without indications, the central controlling unit can, furthermore, dispose a first controlling interface besides the ground controlling seat. The first controlling interface is able to switch the main displaying light to red illuminant for ready to take off aircrafts to wait for entrance outside of the runway.

Hence, when aircrafts are taking off and landing, the warning lanterns on the two sides of the runway can switch from green illuminant to red illuminant status in order according to the track positions of the aircraft. After the aircraft is completely off the runway during a preset time, the warning lanterns on the two sides of the runway and every main displaying light will be displayed in green illuminant again.

More ever, the standby pilot on the ground can indicate that there could be obstacles on the runway when the control tower instructs for permission to take off but the main displaying light or any of the warning lanterns are displaying in red illuminant. At this time, the waiting for take off pilot can make sure the status of the runway with the people in the control tower again. This would avoid obstacles like small animals entering into the runway abruptly and hampering the take off.

When putting the present invention into practice, a departing sensor is disposed in every communication path between the airport runway and taxiway. The departing sensor is connected to the central controlling unit. After the aircraft lands on the runway and enters the taxiway from any communication paths and completely leaves the runway, the departing sensor can emit a departing signal to the central controlling unit. Hence, all the warning lanterns and main displaying lights can be switch to green illuminant.

For better understanding and control of the runway's condition for people in the control tower, the central controlling unit not only can dispose the first controlling interface besides the ground controlling seat, as mentioned above, but also can dispose a second controlling interface besides the entrance controlling seat of the control tower. The first and second controlling interfaces are connected to the central controlling unit and display, synchronized, with every warning lantern and main displaying light. They are all manual controlling devices which can replace automatic control temporarily (override) to increase the warning effect.

Furthermore, to increase the warning effect, the aforementioned warning lanterns, displaying in red illuminant, could use the method of illuminating in interval to produce glitter effect. Hence, the warning effect can be made more distinct.

Comparing to previous technologies, the present invention could provide additional runway real-time information to the pilot and the people in the control tower. Particularly, the obstacles appearing abruptly on the runway can also be warned immediately and to remind other aircrafts, waiting for take off, whether there are aircrafts taking off and landing on the runway.

In conclusion, the airport runway warning system includes a runway, a plurality of warning lanterns respectively disposed on two sides of the runway and parallel to the runway, a plurality of sensors for sensing whether the runway is empty or not, wherein each sensor connects with each corresponding warning lantern; a airport control tower; a central controlling unit disposed on the airport control tower, wherein the warning lanterns and the sensors are electrically connected to the central controlling unit; a plurality of communication paths communicated with the runway; a plurality of main displaying lights electrically connected to the central controlling unit, wherein each main display light is disposed beside a entrance of each corresponding communication path for displaying red or green illuminant; and a plurality of illuminating parts, wherein each two illuminating parts disposed on two sides of each corresponding warning lantern along the runway, and each illuminating part display red or green illuminant.

Therefore, when any obstacle on the runway is sensed by any one sensor, the corresponding warning lantern and all the main displaying lights display red illuminant for warning the runway is not under empty condition.

Moreover, when all the sensors sensed no obstacles near the runway after a period of preset time, all the warning lanterns and the main displaying lights display green illuminant; when any one sensor sensed the obstacle near the runway, the warning lantern connected to the sensor and all the main display lights display red illuminant, the sensor generates a obstacle signal to the central controlling unit at the same time, and other warning lanterns that display red illuminant, due to obstacles sensed earlier, to continue displaying in red illuminant condition; when the control tower permits aircrafts to take off or land, all the main displaying lights display green illuminant via the central controlling unit and causing the illuminating parts, corresponded to the starting end for taking off and landing of aircrafts, of every warning lantern to display green illuminant.

Furthermore, the airport runway warning system further comprises a plurality of departing sensors. Each departing sensor is disposed in the entrance of each corresponding communication path between the runway and a taxiway, and the departing sensors are electrically connected to the central controlling unit. After the aircraft lands on the runway, enters any one taxiway through any one communication path, the departing sensor generates a departing signal to the central controlling unit in order to switch all the warning lanterns and main displaying lights to green illuminant after a period of preset time.

In addition, the airport runway warning system further comprises a first controlling interface disposed beside a ground controlling seat of the control tower. The first controlling interfaces is electrically connected to the central controlling unit for controlling each warning lantern and each main displaying light to display synchronously. The airport runway warning system further comprises a second controlling interface disposed beside a ground controlling seat of the control tower. The second controlling interfaces is electrically connected to the central controlling unit for controlling each warning lantern and each main displaying light to display synchronously. The first controlling interface and the second controlling interface are manual controlling devices.

Moreover, each illuminating part includes a plurality of red LEDs and green LEDs. The sensors are disposed on the warning lanterns, respectively. The airport runway warning system further comprises a plurality of runway lanterns. Each runway lanterns is disposed on an outside of each corresponding warning lanterns and disposed on two shoulders of the two sides of the runway. Each two adjacent sensors are used for sensing whether any one obstacle crosses each two adjacent sensors. Each warning lantern displays intermittently red illuminant for generating glittering effect.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a plane, schematic view of a airport runway warning system according to the best mold of the present invention;

FIG. 2 is a partial enlargement diagram of FIG. 1;

FIG. 3 is a first schematic view of a warning lantern and a sensor according to the best mold of the present invention;

FIG. 4 is a second schematic view of a warning lantern and a sensor according to the best mold of the present invention;

FIG. 5 is a function block of a airport runway warning system according to the best mold of the present invention; and

FIG. 6 is a schematic view of obstacles disposed on a runway.

### DETAILED DESCRIPTION OF THE PREFERRED EMBODIMENTS

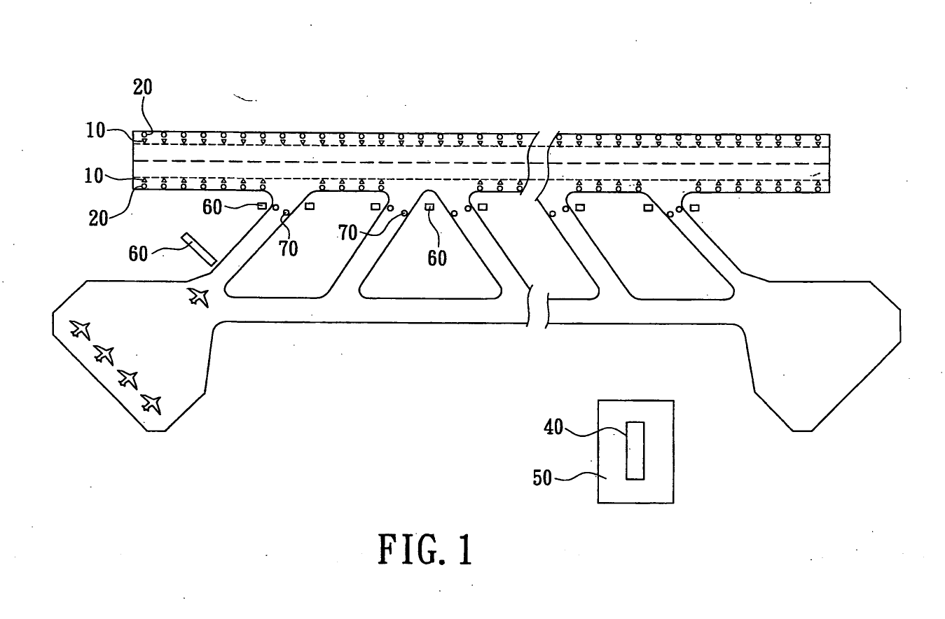

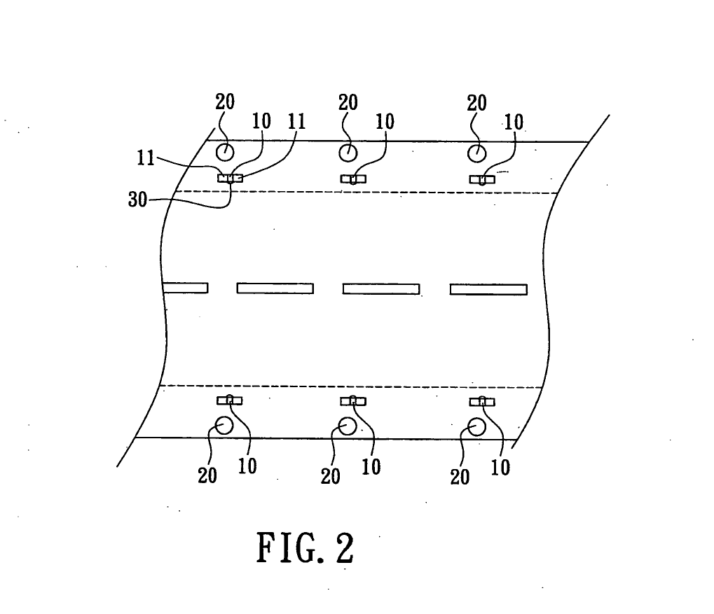

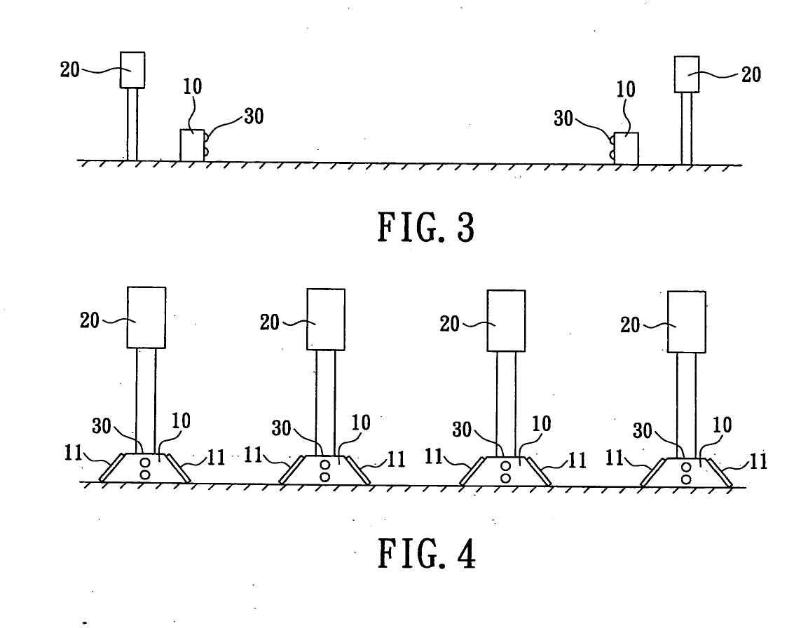

FIGS. 1 and 2 are the best practical example of the plan diagram and the best practical example of warning lanterns diagram of the present invention, respectively. As the figures represent, the airport runway warning system of the present invention disposes a number of warning lanterns 10 parallel to the runway by the two sides of the airport runway. The warning lanterns 10 of the practical example are distributed on the shoulder of the interior of the runway lanterns 20, respectively, on the two sides of the runway. When putting into practice, they also can be disposed in the interval between the runway lanterns 20.

As figure three and four represent, each warning lantern 10 faced to the two ends of the runway has an illuminating part 11. The illuminating part 11 can be switched between red and green illuminant. For example, the illuminating part 11 includes several red and green LED to display switching between red illuminant and green illuminant. When putting into practice, the illuminating part 11 consists of several red and green LED to operate in coordination with the differences in visibility caused by weather to adjust the strength of the beam for reinforcing the degree of recognition.

Every warning lantern 10 is at least connected to one empty sensor 30, to sense the nearby runway zone. The practical example is to place the sensor 30 on top of the warning lantern 10. When putting into practice, the sensor 30 can also be placed on the other locations within the runway zone. The sensor 30 can be utilized by infra-red technology or other RF sensing technologies for sensing, within appropriate height, the ground area of the runway and the ground area.

Furthermore, when putting into practice, interdict or other methods of transmitting and receiving the signal can be used in the interval of every two adjacent sensors 30 for sensing whether vehicles or animals or obstacles are crossing in the interval of every two adjacent sensors 30. Hence, any possible obstacles that could appear on the runway can be accurately sensed.

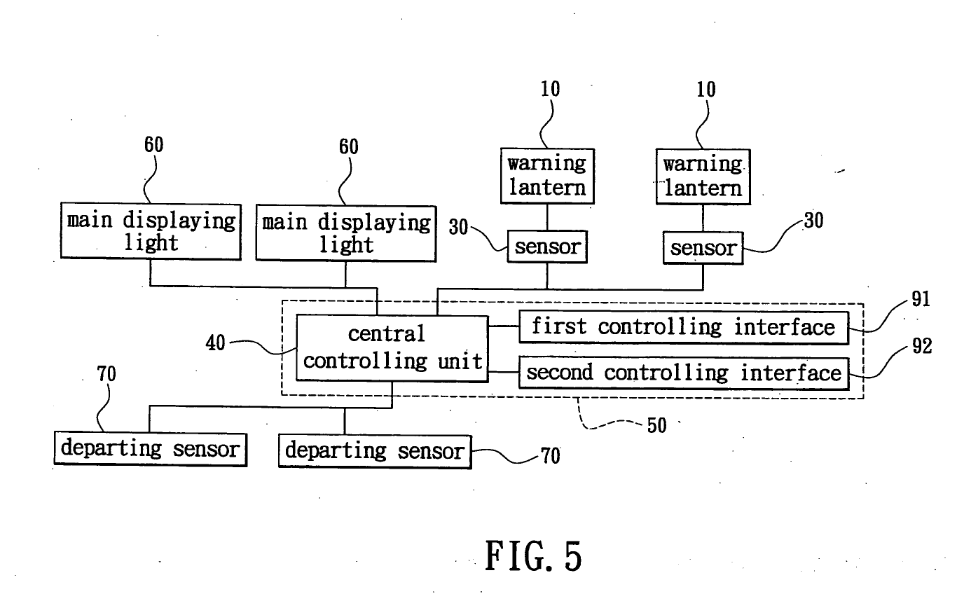

As FIGS. 1 and 5 represent, every warning lantern 10 and sensor 30 are connected to a central controlling unit 40. The central controlling unit 40 is better to be disposed in the control tower 50 for controlling people in the control tower 50 to understand the condition of the runway at anytime.

Secondly, at least one main displaying light 60 is disposed at every entrance of the communication path between the airport runway and the taxiway. The main displaying light 60 is connected to the central controlling unit 40 for switching between red and green illuminant. Also, a departing sensor 70 is disposed at every entrance of the communication path between the airport runway and the taxiway.

The method of coordination and controlling of every aforementioned warning lantern 10, sensor 30, central controlling unit 40, main displaying light 60, departing sensor 70 are as follows:

When all the sensors 30 sensed no obstacles in the nearby runway zone after a period of preset time, all the warning lanterns 10 and the main displaying lights 60 will display green illuminant to indicate that the runway is empty.

When any one sensor 30 sensed obstacles in the nearby runway zone, the warning lantern 30 connected to the sensor 10 will display red illuminant and cause all the main displaying lights 60 to display red illuminant and emit a signal of obstacle to the central controlling unit 40; and at the same time, causing other warning lanterns 10 that display red illuminant, with obstacles sensed earlier, to continue displaying in red illuminant condition for indication of obstacles appearing on the runway.

When the control tower 50 permits aircraft to take off or land, all the main displaying lights 60 and the illuminating parts 11, corresponded to the starting end for taking off and landing of aircrafts, of every warning lantern 10 will display green illuminant via the central controlling unit 40. The illuminating part 11 of the other side of the green illuminant will display red illuminant to avoid reverse gliding on the runway for taking off aircrafts.

Hence, when the aircraft is taking off and landing, the warning lanterns 10 on the two sides of the runway will display green illuminant and switch to red illuminant status in order according to the track positions of the aircraft. After the aircraft is completely off the runway during a preset time, the warning lanterns 10 and the main displaying lights 60 on the two sides of the runway will be displayed in green illuminant again.

At the time of permitting the aircraft to take off, when any sensors 30 of the warning lantern 10 sense obstacles (the permitted aircraft enters into the runway or any obstacles enter into the runway), all the main displaying lights 60 will display in red illuminant condition for warning the pilot that the runway might not be empty.

For example, the standby pilot on the ground can indicate that there could be obstacles on the runway when the control tower instructs for permission to take off but the main displaying light 60 or any of the warning lanterns 10 are displaying in red illuminant. At this time, the waiting for take off pilot can make sure the status of the runway with the people in the control tower again. This would avoid obstacles like small animals entering abruptly into the runway and hampering the take off.

Also, after the aircraft lands on the runway and enters the taxiway from any communication paths and completely leaves the runway, the departing sensor 70 could emit a departing signal to the central controlling unit 40. Hence, to switch all the warning lanterns and main displaying lights to green illuminant.

For better understanding and control of the runway's condition for people in the control tower 50, a first controlling interface 91 can be disposed, further, besides the ground controlling seat and a second controlling interface 92 can be disposed besides the entrance controlling seat. The first and second controlling interfaces are connected to the central controlling unit 40 and display, synchronized, with every warning lantern 10 and main displaying light 60. They are all manual controlling devices which can replace automatic control temporarily (override) to increase warning and control.

For example, under the condition of the aforementioned control tower 50 gives permission for aircrafts to take off or land, all the main displaying lights 60 and the illuminating parts 11, corresponded to the starting end for taking off and landing of aircrafts, of every warning lantern 10 should all display green illuminant. However, to ensure the runway is empty and to avoid situation when aircrafts are waiting for take off in the taxiway to mis-entering the runway without indications, the first controlling interface 91 of the central controlling unit 40 can switch the main displaying light 60 to red illuminant. The aircraft pilot on the ground could easily distinguish that the runway is under do-not-enter condition. Hence, the ready to take off aircrafts can wait outside the runway for entrance. Thus, the goal of avoiding mis-entering the runway without indication can be achieved.

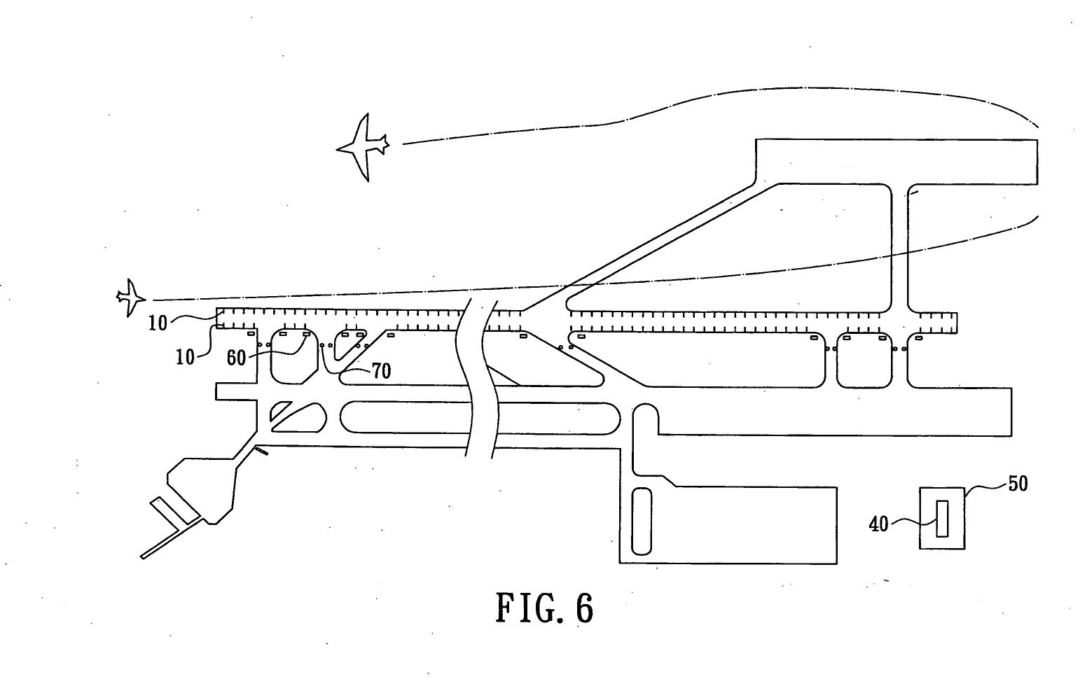

As FIG. 6 represents, when obstacles (for example, construction vehicle or other obstacles) break into the runway abruptly the moment before aircraft's landing and the related controlling people in the control tower 50 do not have to time to realize the obstacles or cannot urgently notify the signal of obstacle to the aircraft pilot, the aircraft pilot is able to realize abnormal condition in first time via the airport runway warning system. The location of the abnormal condition can even be displayed directly by the red illuminant. Therefore, the aircraft pilot can pull up the aircraft to avoid collision. Also, the related workers on the ground are able to search for obstacles in a shortest time and proceed to clear.

Hence, additional runway real-time information can be provided to the pilot and the people in the control tower. Particularly, the obstacles appearing on the runway abruptly can also be warned immediately and to remind other aircrafts, waiting for take off, whether there are aircrafts taking off and landing on the runway.

Although the present invention has been described with reference to the preferred best molds thereof, it will be understood that the invention is not limited to the details thereof. For example, when the aforementioned warning lantern is displaying red illuminant, methods of illuminating in interval could be used to produce the effect of glittering for increasing the distinctiveness of warning effect. Therefore, all such substitutions and modifications are intended to be embraced within the scope of the invention as defined in the appended claims.

What is claimed is:

1. A airport runway warning system, comprising:
a runway;
a plurality of warning lanterns respectively disposed on two sides of the runway and parallel to the runway;
a plurality of sensors for sensing whether the runway is empty or not, wherein each sensor connects with each corresponding warning lantern;
a airport control tower;
a central controlling unit disposed on the airport control tower, wherein the warning lanterns and the sensors are electrically connected to the central controlling unit;
a plurality of communication paths communicated with the runway;
a plurality of main displaying lights electrically connected to the central controlling unit, wherein each main display light is disposed beside a entrance of each corresponding communication path for displaying red or green illuminant; and
a plurality of illuminating parts, wherein each two illuminating parts disposed on two sides of each corresponding warning lantern along the runway, and each illuminating part display red or green illuminant;
whereby, when any obstacle on the runway is sensed by any one sensor, the corresponding warning lantern and all the main displaying lights display red illuminant for warning the runway is not under empty condition.

2. The airport runway warning system as claimed in claim 1, wherein when all the sensors sensed no obstacles near the runway after a period of preset time, all the warning lanterns and the main displaying lights display green illuminant;
wherein when any one sensor sensed the obstacle near the runway, the warning lantern connected to the sensor and all the main display lights display red illuminant, the sensor generates a obstacle signal to the central controlling unit at the same time, and other warning lanterns that display red illuminant, due to obstacles sensed earlier, to continue displaying in red illuminant condition;
wherein when the control tower permits aircrafts to take off or land, all the main displaying lights display green illuminant via the central controlling unit and causing the illuminating parts, corresponded to the starting end for taking off and landing of aircrafts, of every warning lantern to display green illuminant.

3. The airport runway warning system as claimed in claim 1, further comprising a plurality of departing sensors, wherein each departing sensor is disposed in the entrance of each corresponding communication path between the runway and a taxiway, and the departing sensors are electrically connected to the central controlling unit.

4. The airport runway warning system as claimed in claim 3, wherein after the aircraft lands on the runway, enters any one taxiway through any one communication path, the departing sensor generates a departing signal to the central controlling unit in order to switch all the warning lanterns and main displaying lights to green illuminant after a period of preset time.

5. The airport runway warning system as claimed in claim 1, further comprising a first controlling interface disposed beside a ground controlling seat of the control tower, wherein the first controlling interfaces is electrically connected to the central controlling unit for controlling each warning lantern and each main displaying light to display synchronously.

6. The airport runway warning system as claimed in claim 5, further comprising a second controlling interface disposed beside a ground controlling seat of the control tower, wherein the second controlling interfaces is electrically connected to the central controlling unit for controlling each warning lantern and each main displaying light to display synchronously.

7. The airport runway warning system as claimed in claim 6, wherein the first controlling interface and the second controlling interface are manual controlling devices.

8. The airport runway warning system as claimed in claim 1, wherein each illuminating part includes a plurality of red LEDs and green LEDs.

9. The airport runway warning system as claimed in claim 1, wherein the sensors are disposed on the warning lanterns, respectively.

10. The airport runway warning system as claimed in claim 1, further comprising a plurality of runway lanterns, wherein each runway lanterns is disposed on an outside of each corresponding warning lanterns and disposed on two shoulders of the two sides of the runway.

11. The airport runway warning system as claimed in claim 1, wherein each two adjacent sensors are used for sensing whether any one obstacle crosses each two adjacent sensors.

12. The airport runway warning system as claimed in claim 1, wherein each warning lantern displays intermittently red illuminant for generating glittering effect.
